(19) United States
(12) Patent Application Publication
(10) Pub. No.: US 2008/0100521 A1
(43) Pub. Date: May 1, 2008

(54) Antenna assemblies with composite bases

(76) Inventors: Derek Herbert, Auburn Hills, MI (US); Ralf Lindackers, Waterford, MI (US); Hasan Yasin, Holly, MI (US)

Correspondence Address: HARNESS, DICKEY, & PIERCE, P.L.C, 7700 BONHOMME, STE 400, ST. LOUIS, MO, 63105, US

(21) Appl. No.: 11/589,342

(22) Filed: Oct. 30, 2006

(51) Int. Cl. H01Q 1/32

(52) U.S. Cl. 343/713

(57) ABSTRACT

An antenna assembly according to one embodiment is configured to be installed and fixedly mounted to a vehicle body wall after being inserted into a mounting hole in the vehicle body wall from an external side of the vehicle and nipped from the interior compartment side. The antenna assembly may include a composite antenna base, which may be operable as a primary load-bearing structure for transferring loads associated with the antenna assembly to the vehicle body wall. The composite antenna base may integrally define means for mounting a printed circuit board without using mechanical fasteners. The composite antenna base may integrally define one or more resiliently flexible retention members for helping retain the relative position of the composite antenna base to the vehicle body wall before the antenna assembly is fixedly mounted to the vehicle body wall.

### FIELD

The present disclosure generally relates to antenna assemblies mountable to mobile platforms, such as automobile or vehicle roofs, hoods, or trunk lids.

### BACKGROUND

The statements in this section merely provide background information related to the present disclosure and may not constitute prior art.

Various antenna types are used in the automotive industry, including aerial AM/FM antennas, patch antennas, etc. Antennas for automotive use are commonly positioned on the vehicle's roof, hood, or trunk lid to help ensure that the antenna has an unobstructed view overhead or towards the zenith. By way of example, some antenna assemblies include a die cast or stamped metal base that operates as the main load-bearing structure for the antenna assembly when mounted to a vehicle. These die cast or stamped metallic bases can be fairly costly due to the material and manufacturing costs associated therewith, especially when compared to the manufacturing costs associated with the other antenna elements.

### SUMMARY

An antenna assembly according to one embodiment generally includes a load-bearing composite antenna base. The antenna assembly is configured such that, when the antenna assembly is fixedly mounted to a vehicle body wall, the load-bearing composite antenna base is operable as a primary load-bearing structure transferring loads associated with the antenna assembly to the vehicle body wall.

In another embodiment, an antenna assembly generally includes a composite antenna base integrally defining mounting means for a printed circuit board. The antenna assembly may also include a printed circuit board having at least one antenna element. The printed circuit board may be mounted to the mounting means integrally defined by the composite antenna base without mechanical fasteners.

In a further embodiment, an antenna assembly is configured to be installed and fixedly mounted to a vehicle body wall after being inserted into a mounting hole in the vehicle body wall from an external side of the vehicle and nipped from the interior compartment side. In this exemplary embodiment, the antenna assembly generally includes a composite antenna base integrally defining one or more resiliently flexible retention members. The resiliently flexible members are configured to be inserted through the mounting hole and disposed on the interior compartment side of the vehicle body wall to thereby help retain the relative position of the composite antenna base to the vehicle body wall before the antenna assembly is fixedly mounted to the vehicle body wall.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exploded perspective view of an antenna assembly having a composite antenna base and an EMI shield can, where the antenna assembly is configured for receiving satellite signals according to an exemplary embodiment;

FIG. 2 is a side elevation view of the exploded antenna assembly shown in FIG. 1;

FIG. 3 is an outer perspective view of an antenna assembly having a composite antenna base, where the antenna assembly is configured for receiving AM/FM radio signals according to another exemplary embodiment;

FIG. 4 is a perspective cut-away view of another exemplary embodiment of an antenna assembly having a composite antenna base, and which is configured for receiving AM/FM radio signals;

FIG. 5 is a cross-sectional cut view of the antenna assembly shown in FIG. 4;

FIG. 6 is a center cross-sectional view cut generally through a middle of the antenna assembly shown in FIG. 4;

FIG. 7 is a lower perspective view of the antenna assembly shown in FIG. 4;

FIG. 8 is an exploded perspective view of an antenna assembly having a composite antenna base, and that is configured for receiving cellular and/or GPS signals according to another exemplary embodiment; and

FIG. 9 is a perspective view of an exemplary stamped grounding element that may be used with the antenna assembly shown in FIG. 8.

### DETAILED DESCRIPTION

The following description is merely exemplary in nature and is in no way intended to limit the present disclosure, application, or uses. It should be understood that throughout the drawings, corresponding reference numerals indicate like or corresponding parts and features.

Accordingly, aspects of the present disclosure relate to antenna assemblies having composite antenna bases. In yet other aspects, the present disclosure provides composite antenna bases having integrally formed snap retention features, integrally formed PCB mounting features, and/or that are configured as a primary load bearing structure for the antenna assembly. Further aspects relate to methods of assembling and/or installing antenna assemblies having composite antenna bases.

Some embodiments include the combination of a composite antenna base, an EMI shield, and an electrically-conductive insert for retaining a fastener element. Advantageously, these exemplary embodiments may allow for reduced costs, as compared to antenna assemblies having relatively expensive die cast or stamped metal antenna bases.

In some embodiments, a composite antenna base is provided that is operable as the primary load bearing structure for the antenna assembly. For example, the composite antenna base may support (and bear the loads and weight associated with) other components of the antenna assembly, such as the printed circuit board, EMI shield, grounding element, thread provider or insert, radome, environmental cover, heat stake posts, ferrule, antenna mast, etc. In these embodiments, the composite antenna base may transfer loads from the antenna assembly to external supporting structure, such as a vehicle rooftop, hood, trunk lid, or other supporting structure to which the antenna assembly is mounted.

Aspects of the present disclosure also relate to antenna assemblies having composite antenna bases formed from lower-cost materials and/or manufacturing methods, as compared to the antenna bases formed from die cast or stamped metals. The use of composite materials for the antenna base can also allow for reduced part counts through part consolidation or integration. For example, some embodiments include a composite antenna base having integrally formed snap retention features, where the composite antenna base and snap retention features are monolithically formed (e.g., injection molded, etc.) as a single component structure.

During the antenna installation process, the snap retention features may be used for temporarily holding the antenna assembly in place within a mounting hole by virtue of the snap retention features being snapped or disposed under the interior compartment side of the vehicle roof, while the other portion of the antenna base is on the external side of the vehicle roof.

Using a composite antenna base may also provide improved functionality for automotive (and other suitable antenna) environments. For example, composite antenna bases tend to be more corrosion resistant to the environment, weather, and the elements, as compared to antenna bases formed from die cast or stamped metal.

Composite antenna bases may also provide significantly lower cost antenna solutions, improved assembly (e.g., composite antenna base with integrated snap retention features, etc.), and large volume production capability (e.g., injection molding, etc.).

Some embodiments include EMI shielding for one or more electrical components of a printed circuit board of the antenna assembly. For example, this EMI shielding may be provided by using an EMI shield can, which, in turn, may be soldered, press fit, or molded to the printed circuit board. Additionally, or alternatively, a suitable material may be applied to or coated on one or more components of the antenna assembly to thereby provide EMI shielding.

Some embodiments may include one or more sealing members (e.g., an O-ring, a resiliently compressible elastomeric or foam gasket, caulk, adhesives, other suitable packing or sealing members, etc.) for substantially sealing the mounting hole. For example, a sealing member may be at least partially seated within a groove defined along an underside of the composite antenna base. In which case, the sealing helps to inhibit the ingress or penetration of water, moisture, dust or other contaminants through the mounting hole into the interior of the vehicle body. Additionally, or alternatively, a sealing member may also be provided generally between the composite antenna base and the radome. In other embodiments, sealing may be achieved by one or more integral sealing features rather than with a separate sealing mechanism.

Using composite materials for antenna bases also allow for different assembly methods to be used for coupling or attaching the various antenna components to one another. For example, various embodiments include a radome sonically welded to the composite antenna base. In such embodiments, the ultrasonic welding may provide a sufficiently robust seal, such that there is no need for a separate sealing member thereby reducing part count. In other embodiments, a separate sealing member may be provided for sealing the interface generally between the radome and the composite antenna base, to thereby inhibit the ingress or penetration of water, moisture, dust or other contaminants into the interior of the radome.

Additional embodiments may include a radome having reinforcement walls or other features to provide structural reinforcement to the antenna base. In such embodiments, the structural reinforcement provided to the antenna base by the radome may allow for reductions in the amount of material needed for the antenna base.

Some embodiments may include electrically-conductive inserts (e.g., metal thread providers, etc.) to retain a fastening mechanism, such as a threaded bolt, clip, etc. Some embodiments may include one or more heat staked bosses that help retain the relative position of the printed circuit board within the radome. Some embodiments may include a welded perimeter rib or ridge generally between the radome and composite antenna base.

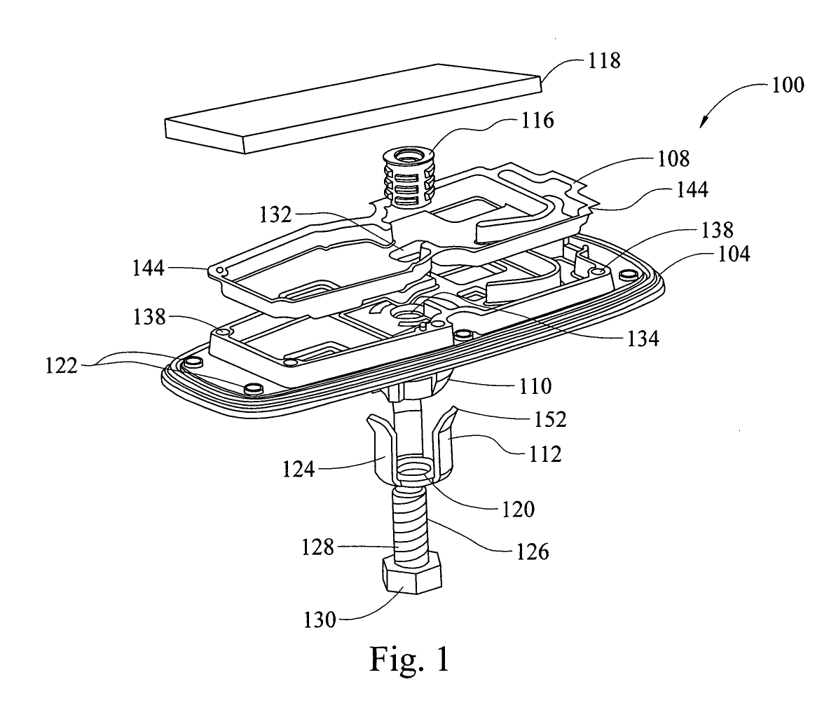

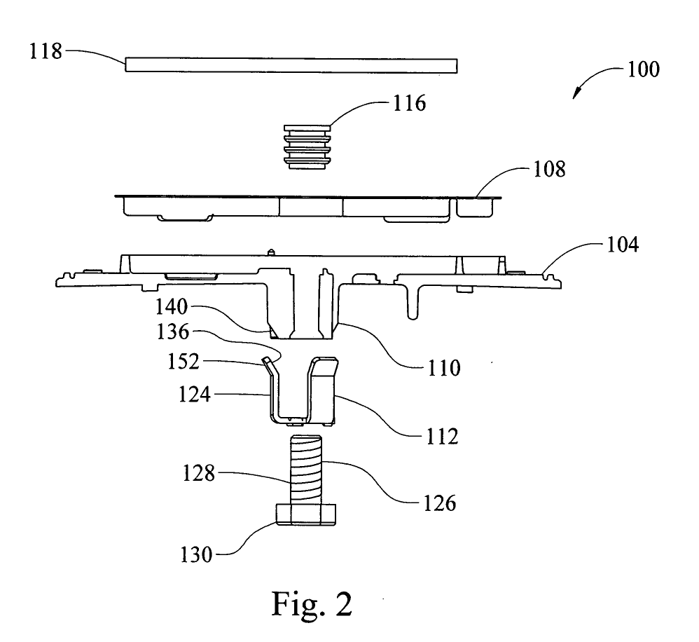

With reference now to FIGS. 1 and 2, there is shown an exemplary antenna assembly 100 embodying one or more aspects of the present disclosure. The antenna assembly 100 includes a composite base or chassis 104, an EMI shielding component 108, a retaining component 112, an insert 116, and a printed circuit board 118.

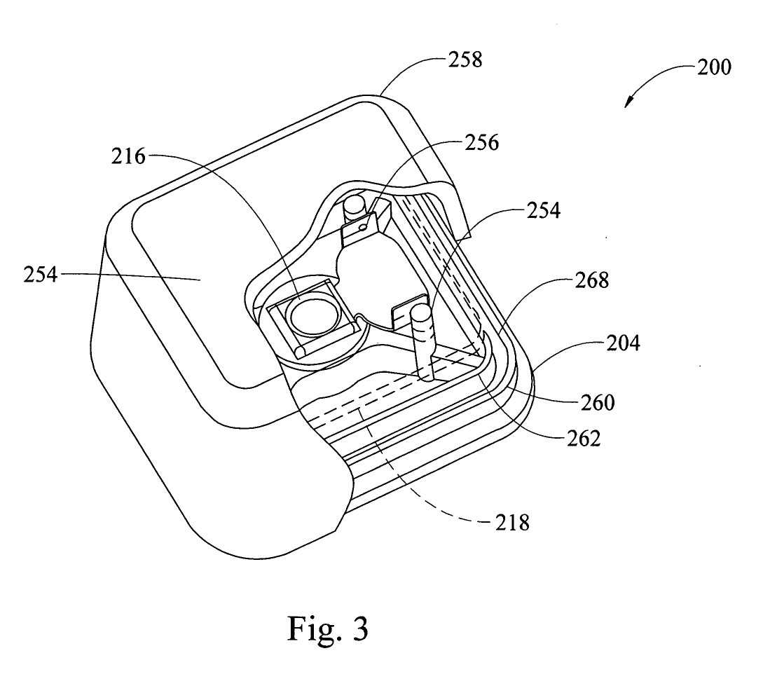

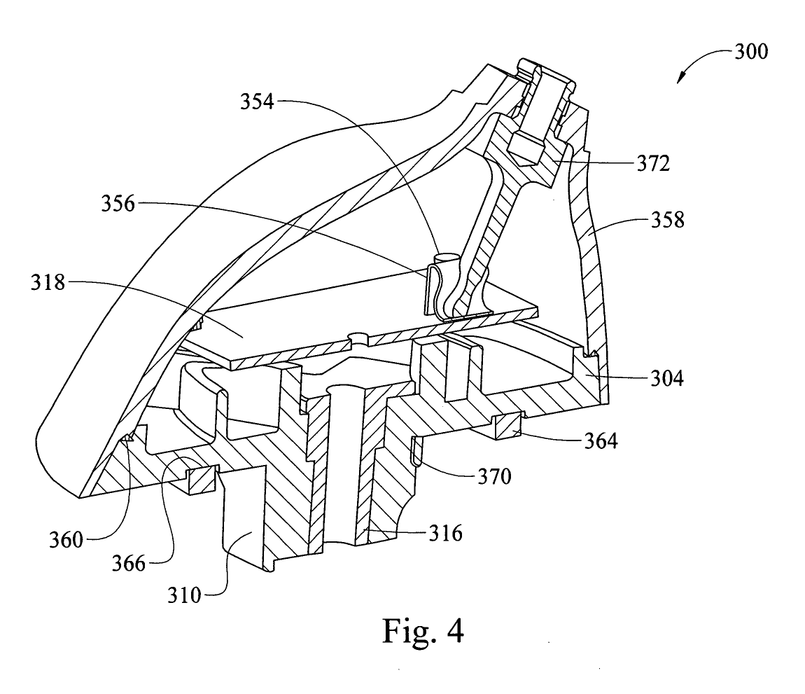

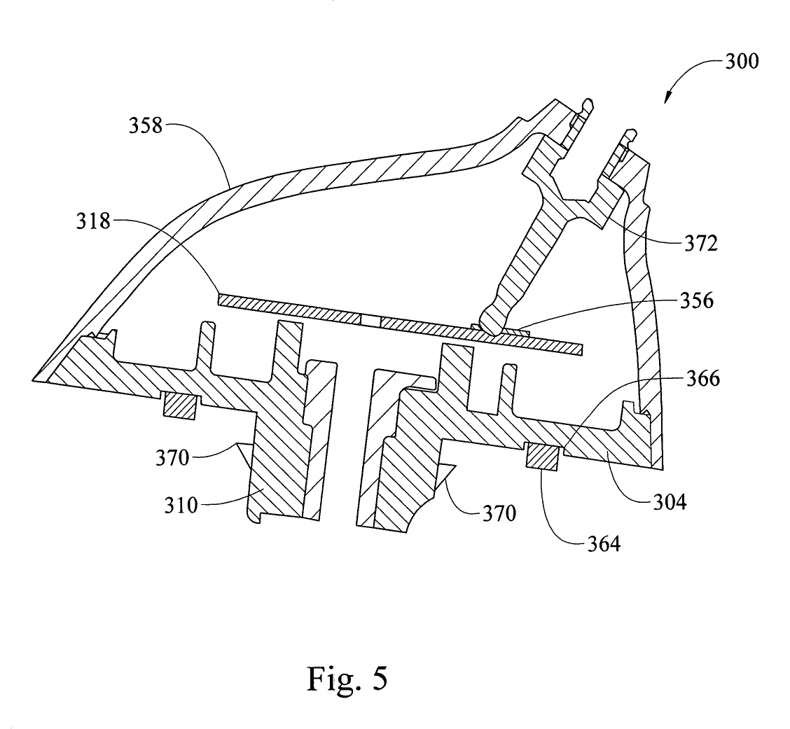

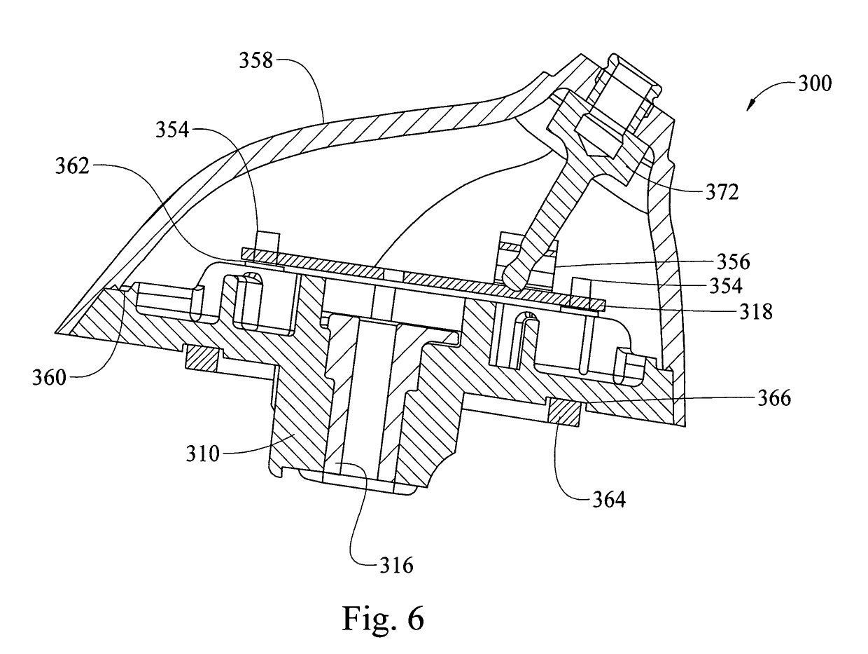

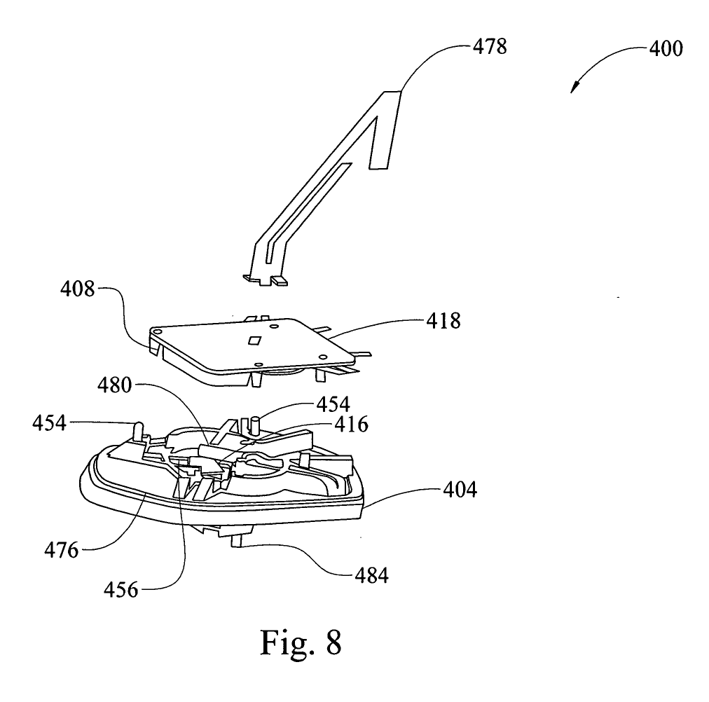

The printed circuit board 118 includes one or more antenna elements. The antenna elements themselves may vary depending, at least in part, on the intended purpose for the antenna assembly 100. In this particular embodiment, the printed circuit board 118 and antenna elements carried thereby are configured for receiving satellite signals, such as Satellite Digital Audio Radio Services (SDARS). Alternative embodiments, however, may be configured for receiving AM/FM radio signals, GPS signals, cellular signals, etc. In this regard, two exemplary antenna assemblies 200 and 300 configured for receiving AM/FM radio signals are described below and respectively shown in FIG. 3 and in FIGS. 4 through 7. In addition, FIG. 8 illustrates an exemplary antenna assembly 400 configured for receiving cellular and/or GPS signals.

Referring back to FIG. 1, the printed circuit board 118 can be secured with screws to the antenna base 104. To this end, the antenna base 104 includes fastener holes 122. Alternatively, the printed circuit board 118 may be secured to the antenna base 104 or another component using other suitable means, such as mounting means integral to the antenna base.

As noted above, the antenna assembly 100 is configured for receiving satellite signals. Given the relatively high frequencies typically associated with satellite signals, the antenna assembly 100 preferably includes EMI shielding. While this EMI shielding can be accomplished in various ways, the illustrated antenna assembly 100 includes an EMI shield can 108. When the antenna assembly 100 is fully assembled, this EMI shield can 108 is sandwiched or disposed generally between the antenna body 104 and the printed circuit board 118. In which case, the EMI shield can 108 is thus operable for shielding the PCB's electronic circuits and/or antenna elements, for example, from electromagnetic interference (EMI) generated by other devices proximal to the antenna assembly 100. Or, for example, the EMI shield can 108 may also help localize the EMI generated by the antenna assembly 100 to thereby help insulate other devices proximal to the antenna assembly 100 from being affected therefrom.

In the illustrated embodiment, the EMI shielding can 108 comprises stamped metal (e.g., steel, tin, etc.) that is preferably soldered to the printed circuit board 118. Alternatively, the antenna assembly 100 may include an EMI shielding component formed from other materials, manufacturing methods, and/or secured via other means. Some embodiments may include an EMI shielding component that is not fixedly attached directly to another antenna component. Instead, the relative positioning of the EMI shielding component may be maintained by virtue of the EMI shielding component being compressively sandwiched between the antenna base and printed circuit board. Additionally, or alternatively, some embodiments include a suitable EMI shielding material applied or coated onto the antenna base and/or other antenna components.

As used herein, the term “EMI” should be considered to generally include and refer to EMI emissions and RFI emissions, and the term “electromagnetic” should be considered to generally include and refer to electromagnetic and radio frequency from external sources and internal sources. Accordingly, the term shielding (as used herein) generally includes and refers to EMI shielding and RFI shielding, for example, to prevent (or at least reduce) ingress and egress of EMI and RFI relative to an electrical component.

Regarding the antenna base 104, a wide range of composite materials may be used for the antenna base 104. Exemplary composite materials include polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some preferred embodiments, the antenna base 104 is injection molded from polymer. Alternative embodiments include antenna bases formed using other materials and/or other manufacturing processes.

As shown in FIG. 1, the antenna base 104 integrally includes or defines a protruding portion 110 configured to be disposed into the mounting hole of a vehicle roof, for example. The protruding portion 110 may also include snap retention features. In which case, the snap retention features may be used for temporarily holding the antenna assembly 100 in place after the snap retention features are inserted through the mounting hole and located on the interior side of the vehicle roof. In such embodiments, the antenna base 104 is preferably formed from one or more composite materials resilient enough to permit the compression or inward deflection/deformation of the snap retention features to allow them to be inserted through the mounting hole, and then to respond with restorative force such that the snap retention features expand and return to their original shape (or something close thereto). Accordingly, the consolidation or integration of the protruding portion 110 and snap retention features with the antenna base 104 may thus allow for reduced part counts, as compared to antenna assemblies in which snap retention features are provided by a discrete component that must be separately attached to the antenna base.

With further reference to FIG. 1, the antenna base 104 also includes holes 138 configured for receiving heat stake posts. The holes 138 are aligned with openings or recessed portions 144 of the EMI shield can 108. Accordingly, heat stake posts may be positioned within the antenna base's holes 138 and EMI shielding component's openings 144. In which case, the heat stake posts may then help retain the relative positioning of the printed circuit board 118, EMI shield can 108, and antenna base 104.

As shown in FIG. 2, the retaining component 112 includes an opening 120 and legs 124. The opening 120 is sized to allow a threaded portion 126 of the fastener member 128 to pass therethrough and be threaded into threads defined by the insert 116. As described below, the retaining component 112, insert 116, and fastener member 128 may be used to securely mount the antenna assembly 100 to a vehicle roof (or other suitable structure).

In the illustrated embodiment, the fastener member 128 comprises a threaded bolt having a hexagonal head 130. Accordingly, an installer may use a socket wrench or other suitable tool to grip the fastener's hexagonal head 130 and then rotate the fastener 128. Alternatively, other embodiments may include different driving elements, fasteners, bolts having differently-shaped or non-hexagonal heads, etc.

When rotated, the threaded bolt is threaded into the corresponding threaded portion associated with the insert 116, which, in turn, is configured to be engagingly received (e.g., friction or interference fit, etc.) within corresponding openings 132 and 134 of the EMI shielding can 108 and antenna base 104, respectively. Alternatively, threads may be integrally defined or formed by the antenna base 104 and EMI shielding can 108.

When the fastener member 128 is threaded into the insert 116, the fastener member 128 captures the retaining component 112 against the antenna base 104. This facilitates antenna installation since the retaining component 112 and fastener member 128 will not fall or drop out as the antenna assembly 100 is being installed. Capturing the components in this exemplary manner also allows the installer (from outside the vehicle) to position the antenna assembly 100 (and components 104, 108, 112, 116, 128 thereof as a single unit into an opening or mounting hole of a vehicle roof.

Also shown in FIG. 2, the retaining component 112 includes three retaining legs 124 having cam surfaces 136. The cam surfaces 136 are configured to contact corresponding tapered or ramped surfaces 140 integrally defined by the antenna base 104. When the retaining component 112 is moved towards the antenna base 104 upon rotation of the fastener member 128, contact between the retaining leg's cam surfaces 136 and the corresponding tapered surfaces 140 may facilitate or cause the retaining legs 124 to deform and expand generally outward. The contact between the end portions 152 of the legs 124 and the interior side of the vehicle roof may also help facilitate or cause the legs 124 to deform and expand generally outward. This outward deformation and flexing of the retaining legs 124 may provide a relatively secure engagement with a vehicle roof. In preferred embodiments, the legs 124 and the ramp surfaces 140 are configured (e.g., dimensionally sized, shaped, etc.) such that the legs 124 (when initially sitting on the ramped surfaces 140) will not catch the inside of the roof cutout portion as they are inserted through the mounting hole in the vehicle roof. The particular configurations for the retaining legs and ramp surfaces may depend, for example, on the particular location at which the antenna assembly is to be used, space considerations, etc. In addition, each retaining leg does not necessarily have to have the same configuration (e.g., size, shape, etc.). Preferably, the retaining legs are configured (e.g., shaped, sized, formed of materials, etc.) so that the material(s) (e.g., stainless steel, etc.) from which the retaining legs are formed does not fail during the deformation with a safety margin. Alternative embodiment may include more or less than three retaining legs, and/or retaining legs having different configurations (e.g., shapes, dimensions, L-shaped feet, L-shaped feet, etc.) than what is shown in the figures.

As noted above, the insert 116 provides structure (e.g., threads, etc.) for engaging the fastener member 128. The insert 116 is configured to be engagingly received within corresponding openings 132 and 134 of the EMI shield can 108 and antenna base 104, respectively. In some preferred embodiments, the insert 116 is configured (e.g., sized, shaped, etc.) so as to form a friction or interference fit with the EMI shield can 108 and antenna base 104. Additionally, or alternatively, the insert 116 may also be attached to the EMI shield can 108 and/or antenna base 104 via other means (e.g., adhesives, welding, etc.).

The insert 116 is preferably electrically-conductive so as to form at least a portion of a grounding or electric transmission path from the printed circuit board 118 to the vehicle roof. In such preferred embodiments, at least a portion of the insert 116 may electrically contact at least one electrically-conductive surface of the printed circuit board 118, such as a grounding trace or a board-mounted electrical component. In addition, the insert 116 may be formed from a wide range of materials (e.g., metals, materials rendered electrically conductive, etc.) and manufacturing methods (e.g., die casting, etc.).

A housing or radome may be also provided for enclosing components of the antenna assembly 100. The housing may be seated generally upon the antenna base 104. The housing may be formed from a wide range of materials, such as polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some embodiments, the radome and antenna base 104 are formed from compatible composite materials such that the radome may be attached to the composite antenna base 104 via ultrasonic welding. Alternatively, the radome may be attached to the antenna base 104 via other suitable means, such as interference or snap fit, solvent welding, heat staking, latching, bayonet connections, hook connections, integrated fastening features, mechanical fasteners, combinations thereof, etc.

One or more sealing members (e.g., O-rings, resiliently compressible elastomeric or foam gaskets, etc.) may also be provided for the antenna assembly 100. For example, a sealing member may be provided to substantially seal the mounting hole in which the antenna assembly 100 is mounted, to thereby inhibit the ingress or penetration of water, moisture, dust or other contaminants through the mounting hole into the interior of the vehicle body. As another example, a sealing member may also be provided generally between the antenna base 104 and the radome. Alternatively, or additionally, sealing may be achieved by one or more sealing features integrally formed or defined by the antenna base 104.

With further reference to FIGS. 1 and 2, an exemplary process will now be described for mounting the antenna assembly 100 to a vehicle roof. First, the threaded portion 126 of the fastener 128 is passed through the opening 120 of the retaining component 112, and partially threaded into the insert 116. The insert 116, in turn, is engagingly received within the openings 132 and 134 of the EMI shield can 108 and antenna base 104, respectively. At this stage of the process, the fastener member 128 captures the retaining component 112 against the protruding portion 110 integral to the antenna base 104.

The antenna assembly 100 may then be positioned (from outside the vehicle) as a single unit into a mounting hole of the vehicle roof. As the antenna assembly 100 is moved downwardly relative to the vehicle roof, the snap retention features (integrally defined by the antenna base 104) will be temporarily deformed or distorted inward. In this stage of the process, the antenna assembly 100 is temporarily held in place by virtue of the interaction of the snap retention features, vehicle roof, and antenna base 104. That is, the snap retention features are disposed under the interior compartment side of the vehicle roof, while the upper remaining portion of the base 104 is disposed on the exterior side of the vehicle roof.

The installer may then enter the vehicle and use a socket wrench or other tool to grip the hexagonal head 130, and rotate the fastener member 128. This rotation drives the fastener member 128 for moving the retaining component 112, such that the legs 124 are deformed and expanded generally outwardly relative to the vehicle roof. In this exemplary manner, the antenna assembly 100 may thus be secured to the vehicle roof in a final installed position.

FIG. 3 illustrates another embodiment of an antenna assembly 200 embodying one or more aspects of the present disclosure. As shown in FIG. 3, the antenna assembly 200 includes a composite base 204, an insert 216, and a printed circuit board 218. This particular antenna assembly 200 is configured for receiving AM/FM radio signals, which are at relatively low frequencies as compared to satellite signals, such that EMI shielding is not provided for in this embodiment. Alternatively, other embodiments may include EMI shielding.

With further reference to FIG. 3, the antenna assembly 200 includes heat stake posts 254 and at least one grounding element 256 disposed between a corresponding pair of the heat stake posts 254. The grounding element 256 may be formed from a wide range of electrically-conductive materials (e.g., metals, materials rendered electrically conductive, etc.) and manufacturing methods (e.g., stamping, etc.).

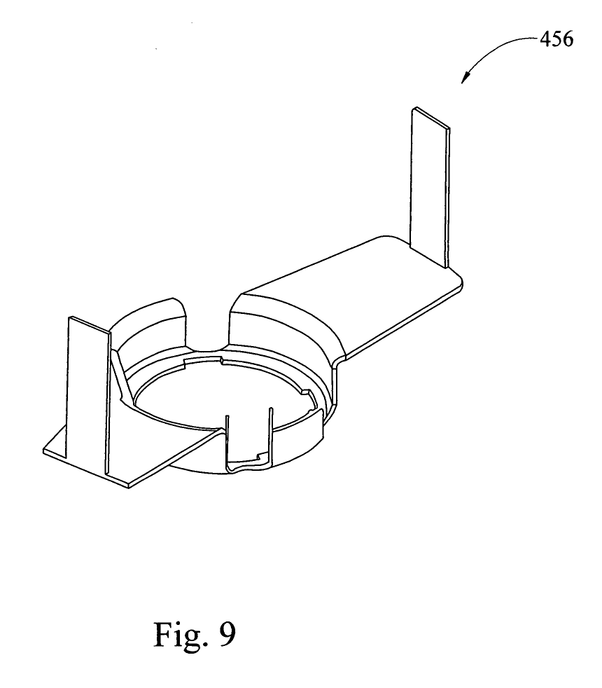

The heat stake posts 254 are engagingly received within openings of the antenna base 104, and pass through holes in the printed circuit board 218. In this exemplary manner, the heat stake posts 254 help retain the relative positioning of the printed circuit board 218 within the antenna radome 258. The relative positioning of the printed circuit board 218 may also be at least partially retained by a retaining wall or rib member 262 integrally defined or formed by the antenna base 204. That is, the printed circuit board 218 may be at least partially positioned within the opening defined by the wall 262. In which case, contact between the sides of the printed circuit board 218 and the retaining wall 262 will inhibit movement of the printed circuit board 218. Alternatively, the printed circuit board 218 may be secured using other suitable means, such as screws, other mechanical fasteners, etc. For example, other embodiments may include one or more grounding elements configured for securing a printed circuit board to an insert without any such heat posts. To this end, FIG. 8 illustrates an antenna assembly 400 that includes a grounding element 456 (also shown in FIG. 9) that is configured to help secure a printed circuit board 418 to an insert 416 without heat posts.

With reference back to FIG. 2, the antenna base 204 may be formed from a wide range of composite materials. Exemplary composite materials include polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some preferred embodiments, the antenna base 204 is injection molded from polymer. Alternative embodiments include antenna bases formed using other materials and/or other manufacturing processes.

The antenna base 204 integrally includes or defines a reinforcement/retaining wall or rib member 262. The antenna base 204 may also integrally include or define a lower protruding portion, which, in turn, integrally includes or defines snap retention features. See, for example, the snap retention features 370 shown in FIGS. 4, 5 and 7. As disclosed herein, snap retention features may be used to temporarily hold the antenna assembly in place within a mounting hole of a vehicle roof, for example, after the snap retention features have been inserted through the mounting hole and are located on the interior compartment side of the vehicle roof.

In some embodiments, the antenna assembly 200 may be mounted to a vehicle roof in a substantially similar manner as that described above for the antenna assembly 100 shown in FIGS. 1 and 2. In such embodiments, the insert 216 provides structure (e.g., threads, etc.) for engaging a fastener member. Alternatively, the antenna assembly 200 may be mounted via other suitable means.

As shown in FIG. 3, the insert 216 is engagingly received within a corresponding opening of the antenna base 204. In some preferred embodiments, the insert 216 is configured (e.g., sized, shaped, etc.) so as to form a friction or interference fit with the antenna base 204. Additionally, or alternatively, the insert 216 may also be attached to the antenna base 204 via other means (e.g., adhesives, welding, etc.). In still further embodiments, threads may be integrally defined or formed by the antenna base 204.

The insert 216 is preferably electrically-conductive so as define at least a portion of a grounding or electric transmission path from the printed circuit board 218 to the vehicle roof. In such preferred embodiments, at least a portion of the insert 216 may electrically contact at least one electrically-conductive surface of the printed circuit board 218, such as a grounding trace or a board-mounted electrical component. In addition, the insert 216 may be formed from a wide range of materials (e.g., metals, materials rendered electrically conductive, etc.) and by a wide range of manufacturing methods (e.g., die casting, etc.).

The housing or radome 258 may also be formed from a wide range of materials, such as polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some embodiments, the housing 258 and antenna base 204 are formed from compatible composite materials that allow the housing 258 to be attached to the composite antenna base 204 via ultrasonic welding (as generally represented by the welded perimeter rib 260). Alternatively, the housing 258 may be attached to the antenna base 204 via other suitable means, such as interference or snap fit, solvent welding, heat staking, latching, bayonet connections, hook connections, integrated fastening features, mechanical fasteners, combinations thereof, etc.

FIG. 3 also shows a sealing member 268 (e.g., an O-ring, etc.) generally between the antenna base 204 and the housing 258. The antenna assembly 200 may also include one or more sealing members for substantially sealing the mounting hole in which the antenna assembly 200. Alternatively, or additionally, sealing may be achieved by one or more sealing features integrally formed or defined by the antenna base 204.

FIGS. 4 through 7 illustrates another embodiment of an antenna assembly 300 embodying one or more aspects of the present disclosure. This particular antenna assembly 300 is also configured for receiving AM/FM radio signals. As shown in FIG. 4, the antenna assembly 300 includes a composite base 304, an insert 316, a printed circuit board 318, and a ferrule 372 for receiving an antenna mast.

The antenna assembly 300 also includes heat stake posts 354 and grounding elements 356 disposed between corresponding pairs of the heat stake posts 354. The grounding elements 356 may be formed from a wide range of electrically-conductive materials (e.g., metals, materials rendered electrically conductive, etc.) and by a wide range manufacturing methods (e.g., stamping, etc.).

The heat stake posts 354 are engagingly received within openings of the antenna base 304, and pass through holes in the printed circuit board 318. In this exemplary manner, the heat stake posts 354 help retain the relative positioning of the printed circuit board 318 within the housing 358. The relative positioning of the printed circuit board 318 may also be at least partially retained by a wall or rib member 362 integrally defined or formed by the antenna base 204. Alternatively, the printed circuit board 318 may be secured using other suitable means, such as screws, other mechanical fasteners, etc.

The antenna base 304 may be formed from a wide range of composite materials, such as polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some preferred embodiments, the antenna base 304 is injection molded from polymer. Alternative embodiments include antenna bases formed using other materials and/or other manufacturing processes.

As shown in FIGS. 4, 5, and 7, the antenna base 304 integrally includes or defines a lower protruding portion 310, which, in turn, integrally includes or defines snap retention features 370. The snap retention features 370 may be used to temporarily hold the antenna assembly 300 in place within a mounting hole of a vehicle roof, for example, after the snap retention features 370 have been inserted through the mounting hole. At which point, the snap retention features 370 will be disposed under the interior compartment side of the vehicle roof, while the remaining upper portion of the antenna base 304 is on the external side of the vehicle roof. Accordingly, the antenna base 304 is preferably formed from one or more composite materials resilient enough to permit the compression or inward deflection/deformation of the snap retention features to allow them to be inserted through the mounting hole, and then to respond with restorative force such that the snap retention features expand and return to their original shape (or something close thereto).

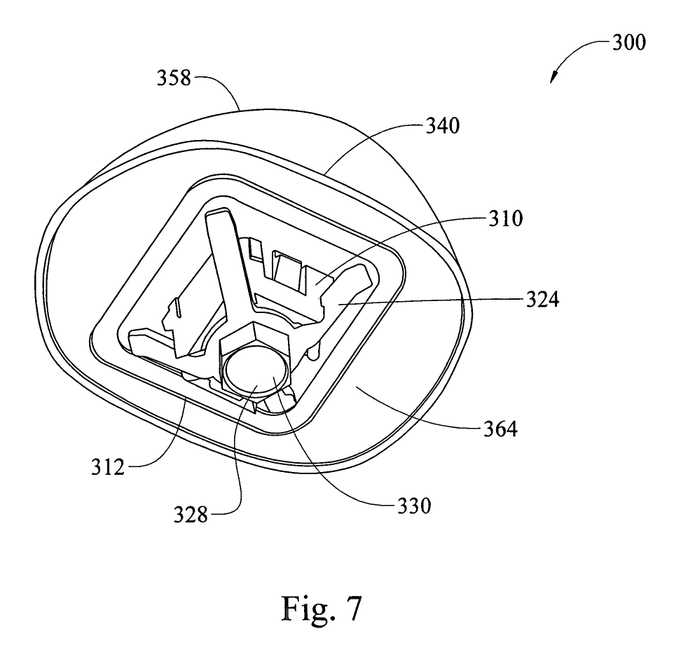

FIG. 7 shows the retaining component 312 and fastener member 318, which may be used to securely mount the antenna assembly 300 to a vehicle roof (or other suitable structure). In this particular example, the retaining component 312 includes legs 324 and an opening through which the fastener member 328 passes to engage the insert 316.

In the illustrated embodiment, the fastener member 328 comprises a threaded bolt having a hexagonal head 330. Accordingly, an installer may use a socket wrench or other suitable tool to grip the fastener's hexagonal head 330 and then rotate the fastener 328. Alternative embodiments may include other suitable driving elements, fasteners, bolts having differently-shaped or non-hexagonal heads, etc.

As shown in FIG. 7, the fastener member 328 captures the retaining component 312 against the antenna base 304. This facilitates antenna installation since the retaining component 312 and fastener member 328 will not fall or drop out as the antenna assembly 300 is being installed. Capturing the components in this exemplary manner also allows the installer (from outside the vehicle) to position the antenna assembly 300 (and components 304, 312, 316, 328 thereof) as a single unit into an opening or mounting hole of a vehicle roof.

The retaining component 312 shown in FIG. 7 includes four retaining legs 324 having cam surfaces. The cam surfaces are configured to contact corresponding tapered or ramped surfaces 340, which may be integrally defined by the antenna base 304. With the relative movement of the retaining component 312 towards the antenna base 304 upon rotation of the fastener member 328, contact between the retaining leg's cam surfaces and the corresponding tapered surfaces 340 can facilitate or cause the retaining legs 324 to deform and expand generally outward. The contact between the legs 324 and the interior side of the vehicle roof may also help facilitate or cause the legs 324 to deform and expand generally outward. This outward deformation and flexing of the retaining legs 324 may provide a relatively secure engagement with a vehicle roof. In preferred embodiments, the legs 324 and the ramp surfaces 340 are configured (e.g., dimensionally sized, shaped, etc.) such that the legs 324 (when initially sitting on the ramped surfaces 340) will not catch the inside of the roof cutout portion as they are inserted through the mounting hole in the vehicle roof. The particular configuration for the retaining legs and ramp surfaces may depend, for example, on the particular location at which the antenna assembly is to be used, space considerations, etc. In addition, each retaining leg does not necessarily have to have the same configuration (e.g., size, shape, etc.). Preferably, the retaining legs are configured (e.g., shaped, sized, formed of materials, etc.) so that the material(s) (e.g., stainless steel, etc.) from which the retaining legs are formed does not fail during the deformation with a safety margin. Alternative embodiment may include more or less than four retaining legs, and/or retaining legs having different configurations (e.g., shapes, dimensions, L-shaped feet, L-shaped feet, etc.) than what is shown in the figures.

With further reference to FIGS. 4 through 6, the insert 316 is engagingly received within the opening of the antenna base 304. In some preferred embodiments, the insert 316 is configured (e.g., sized, shaped, etc.) so as to form a friction or interference fit with the antenna base 304. Additionally, or alternatively, the insert 316 may also be attached to the antenna base 304 via other means (e.g., adhesives, welding, etc.). In still further embodiments, threads may be integrally defined or formed by the antenna base 304.

The insert 316 is preferably electrically-conductive so as define at least a portion of a grounding or electric transmission path from the printed circuit board 318 to the vehicle roof. In such preferred embodiments, at least a portion of the insert 316 may electrically contact at least one electrically-conductive surface of the printed circuit board 318, such as a grounding trace or a board-mounted electrical component. In addition, the insert 316 may be formed from a wide range of materials (e.g., metals, materials rendered electrically conductive, etc.) and by a wide range of manufacturing methods (e.g., die casting, etc.).

The radome 358 may be formed from a wide range of materials, such as polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some embodiments, the radome 358 and antenna base 304 are formed from compatible composite materials that allow the radome 358 to be attached to the composite antenna base 304 via ultrasonic welding (as generally represented by the weld area 360). Alternatively, the radome 358 may be attached to the antenna base 304 via other suitable means, such as interference or snap fit, solvent welding, heat staking, latching, bayonet connections, hook connections, integrated fastening features, mechanical fasteners, combinations thereof, etc.

A sealing member 364 (e.g., a foam gasket, etc.) is provided for substantially sealing the interface between the underside of the antenna base 304 and the external side of the vehicle roof. As shown in FIGS. 4 through 6, the seal 364 is seated within a groove 366 generally surrounding the antenna base's protruding portion 310. Preferably, the seal 364 prevents (or at least inhibits) the ingress or penetration of water, moisture, dust or other contaminants through the mounting hole into the interior of the vehicle. In some preferred embodiments, the seal 364 is formed from a sufficiently resilient material (e.g., elastomeric or foam material, etc.) that allows the seal 364 to be compressively seated at least partially within the groove 366 such that the seal 364 will not drop or fall out as the antenna assembly 300 is being mounted to a vehicle roof. Alternatively, or additionally, sealing may be achieved by one or more sealing features integrally formed or defined by the antenna base 304.

FIG. 8 illustrates another exemplary antenna assembly 400 embodying one or more aspects of the present disclosure. As shown in FIG. 8, the antenna assembly 400 includes a composite base or chassis 404, an insert 416, and a printed circuit board 418.

This particular antenna assembly 400 is configured for receiving cellular signals and GPS signals. To this end, FIG. 8 illustrates an exemplary antenna element 478 (e.g., stamped metal element, etc.) and coaxial cables 480, 484 routed through the antenna assembly 400. The coaxial cable 480 may be used for communicating cellular signals received by the antenna assembly 400 to another device. The coaxial cable 484 may be used for communicating GPS signals received by the antenna assembly 400 to another device. Alternatively, other suitable antenna elements and communication links may be used.

Because this particular antenna assembly 400 is configured for receiving satellite signals at relatively high frequencies, this embodiment preferably includes at least some EMI shielding. As shown in FIG. 8, the antenna assembly 400 includes an EMI shield can 408 soldered to the printed circuit board 418. Alternatively, or additionally, EMI shielding may be provided by other means, such as EMI shielding components formed from other materials, manufacturing methods, and/or affixed via other means, etc. In addition, other embodiments may include an EMI shield can that is not fixedly attached directly to another antenna component. Instead, the relative positioning of the EMI shielding can may be maintained by virtue of the EMI shielding can being compressively sandwiched between the antenna base and printed circuit board. As an alternative (or in addition) to an EMI shield can, some embodiments include a suitable material applied or coated onto the antenna base and/or other antenna component for providing EMI shielding.

Regarding the antenna base 404, a wide range of composite materials may be used for the antenna base 404. Exemplary composite materials include Exemplary composite materials include polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some preferred embodiments, the antenna base 404 is injection molded from polymer. Alternative embodiments include antenna bases formed using other materials and/or other manufacturing processes.

The antenna base 404 may integrally include or define a lower protruding portion, which, in turn, integrally includes or defines snap retention features. See, for example, the snap retention features 370 shown in FIGS. 4, 5 and 7. In such embodiments, the snap retention features may be used to temporarily hold the antenna assembly 400 in place within a mounting hole of a vehicle roof, for example, after the snap retention features have been inserted through the mounting hole and are located on interior compartment side of the vehicle roof.

In some embodiments, the antenna assembly 400 may be mounted to a vehicle roof in a substantially similar manner as that described above for the antenna assembly 100 shown in FIGS. 1 and 2. Alternatively, the antenna assembly 400 may be mounted via other suitable means.

With further reference to FIG. 8, the antenna base 404 integrally includes or defines posts 454. The posts 454 are engagingly received within openings of the EMI shield can 408 and openings 480 of the printed circuit board 418. In this exemplary manner, the posts 454 thus help retain the relative positioning of the printed circuit board 418 and EMI shield can 408. Alternatively, the printed circuit board 418 and/or EMI shield 408 may be secured using other suitable means, such as screws, other mechanical fasteners, etc.

The antenna base 404 also integrally defines a ridge or shoulder 476. The shoulder 476 extends generally around the perimeter of the antenna base 404. Accordingly, an O-ring or other suitable sealing member may be seated against the shoulder 476 to substantially seal an interface between the antenna base 404 and a housing or radome. The O-ring prevents (or at least inhibits) the ingress or penetration of water, moisture, dust, or other contaminants through the interface into the interior of the housing.

The antenna base 404 also includes a weld area 460 sufficiently sized so as to permit ultrasonically welding of a composite housing or radome to the antenna base 404. Therefore, the housing may be formed from a wide range of materials, such as polymers, urethanes, plastic materials (e.g., polycarbonate blends, Polycarbonate-Acrylnitril-Butadien-Styrol-Copolymer (PC/ABS) blend, etc.), glass-reinforced plastic materials, synthetic resin materials, thermoplastic materials (e.g., GE Plastics Geloy® XP4034 Resin, etc.), among other suitable materials. In some embodiments, the housing and antenna base 404 are formed from compatible composite materials that allow the housing to be attached to the composite antenna base 404 via ultrasonic welding. Alternatively, the housing may be attached to the antenna base 404 via other suitable means, such as interference or snap fit, heat staking, solvent welding, latching, bayonet connections, hook connections, integrated fastening features, mechanical fasteners, combinations thereof, etc.

As shown in FIG. 8, the insert 416 is engagingly received within a corresponding opening of the antenna base 404. In some preferred embodiments, the insert 416 is configured (e.g., sized, shaped, etc.) so as to form a friction or interference fit with the antenna base 404. Additionally, or alternatively, the insert 416 may also be attached to the antenna base 404 via other means (e.g., adhesives, welding, etc.).

The insert 416 is preferably electrically-conductive so as define at least a portion of a grounding or electric transmission path from the printed circuit board 418 to the vehicle roof. In such preferred embodiments, at least a portion of the insert 416 may electrically contact at least one electrically-conductive surface of the printed circuit board 418, such as a grounding trace or a board-mounted electrical component. In addition, the insert 416 may be formed from a wide range of materials (e.g., metals, materials rendered electrically conductive, etc.) and manufacturing methods (e.g., die casting, etc.).

A sealing member may be provided between the underside of the antenna base 404 and the external side of the vehicle roof for substantially sealing the mounting hole. Alternatively, or additionally, sealing may be achieved by one or more sealing features integrally formed or defined by the antenna base 404.

The antenna assembly 400 may also include a stamped metal grounding element 456. In this embodiment, a grounding path may thus be formed from the printed circuit board 418 to the vehicle roof by way of the grounding element 456, insert 416, fastener member, and retaining component.

An exemplary grounding element 456 is shown in FIG. 9. In other embodiments, however, other grounding elements may be used with different shapes, sizes, positioned at other locations, formed from different materials, and/or alternative manufacturing methods besides stamping. Still further embodiments may not include a grounding element. Accordingly, the presence and particular grounding element configuration (e.g., shape, size, location, material, manufacturing method, etc.) used for a particular antenna assembly may depend, at least in part, on the intended function for the antenna assembly, e.g., AM/FM, Satellite Digital Audio Radio Services (SDARS), Global Positioning System (GPS), cellular signals, etc. For example, an antenna assembly configured for AM/FM applications (e.g., antenna assembly 200 shown in FIG. 3, antenna assembly 300 shown in FIGS. 4 through 7, etc.) may include a grounding element that comprises a set of pins or stampings for providing a direct current path from the printed circuit board to an electrically-conductive insert. As another example, an antenna assembly configured for GPS and/or cellular applications (e.g., antenna assembly 400 shown in FIG. 8, etc.) may include a grounding element that is required to be a particular or specific shape (e.g., grounding element 456 in FIG. 9, etc.) that satisfies RF functionality of the antenna.

It should be noted that embodiments and aspects of the present disclosure can be used in a wide range of antenna applications, such as patch antennas, telematics antennas, antennas configured for receiving satellite signals (e.g., Satellite Digital Audio Radio Services (SDARS), Global Positioning System (GPS), cellular signals, etc.), antennas configured for receiving RF energy or radio transmissions (e.g., AM/FM radio signals, etc.), combinations thereof, among other applications in which wireless signals are communicated between antennas. Accordingly, the scope of the present disclosure should not be limited to only one specific form/type of antenna assembly.

In addition, various antenna assemblies and components disclosed herein can be mounted to a wide range of supporting structures, including stationary platforms and mobile platforms. For example, an antenna assembly disclosed herein could be mounted to supporting structure of a bus, train, aircraft, among other mobile platforms. Accordingly, the specific references to automobiles or vehicles herein should not be construed as limiting the scope of the present disclosure to any specific type of supporting structure or environment.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An antenna assembly configured to be installed and fixedly mounted to a vehicle body wall after being inserted into a mounting hole in the vehicle body wall from an external side of the vehicle and nipped from the interior compartment side, the antenna assembly comprising a load-bearing composite antenna base, wherein the antenna assembly is configured such that, when the antenna assembly is fixedly mounted to the vehicle body wall, the load-bearing composite antenna base is operable as a primary load-bearing structure transferring loads associated with the antenna assembly to the vehicle body wall.

2. The antenna assembly of claim 1, further comprising a printed circuit board having at least one antenna element, and coupled to the load-bearing composite antenna base such that the weight of the printed board circuit is borne by the load-bearing composite antenna base, thereby allowing the load-bearing composite antenna to transfer loads arising from the weight of the printed circuit board to the vehicle body wall.

3. The antenna assembly of claim 1, wherein the load-bearing composite antenna base integrally defines means for mounting a printed circuit board without using mechanical fasteners.

4. The antenna assembly of claim 1, wherein the load-bearing composite antenna base integrally defines at least one post configured to be engagingly received within at least one opening of a printed circuit board for inhibiting relative movement between the printed circuit board and the load-bearing composite antenna base.

5. The antenna assembly of claim 1, wherein the load-bearing composite antenna base integrally defines a retaining wall configured for contacting at least a portion of a printed circuit board, to thereby inhibit relative movement between the printed circuit board and the load-bearing composite antenna base.

6. The antenna assembly of claim 1, wherein the load-bearing composite antenna base integrally defines one or more resiliently flexible retention members configured to be inserted through the mounting hole and disposed on the interior compartment side of the vehicle body wall, to thereby help retain the relative position of the load-bearing composite antenna base to the vehicle body wall before the antenna assembly is fixedly mounted to the vehicle body wall.

7. The antenna assembly of claim 1, further comprising at least one grounding element that forms at least a portion of a path to ground for the antenna assembly to the vehicle body wall.

8. The antenna assembly of claim 1, further comprising a radome attached to the load-bearing composite antenna base, without mechanical fasteners, by at least one or more of a snap fit, heat staking, solvent welding, or sonic welding.

9. The antenna assembly of claim 1, further comprising a radome coupled to the load-bearing composite antenna base, and at least one sealing member disposed for substantially sealing the interface defined generally between the radome and the load-bearing composite antenna base, to thereby inhibit the ingress of contaminants through the interface into the interior enclosure collectively defined by the radome and load-bearing composite antenna base, wherein the load-bearing composite antenna base integrally defines at least one shoulder generally along the interface, and wherein the at least one sealing member is seated generally against the at least one shoulder.

10. The antenna assembly of claim 1, wherein the load-bearing composite antenna base includes an opening, and wherein the antenna assembly further comprises an electrically-conductive insert at least partially positioned within the opening of the load-bearing composite antenna base such that the electrically-conductive insert forms at least a portion of a path to ground for the antenna assembly to the vehicle body wall, the electrically-conductive insert configured for retaining a fastener element.

11. The antenna assembly of claim 10, wherein the electrically-conductive insert is internally threaded for threadedly engaging a threaded portion of a mechanical fastener.

12. The antenna assembly of claim 1, wherein the load-bearing composite antenna base is made from polymer.

13. An antenna assembly configured to be installed and fixedly mounted to a vehicle body wall after being inserted into a mounting hole in the vehicle body wall from an external side of the vehicle and nipped from the interior compartment side, the antenna assembly comprising:
a composite antenna base integrally defining mounting means for a printed circuit board; and
a printed circuit board having at least one antenna element, and mounted to said mounting means integrally defined by the composite antenna base without mechanical fasteners.

14. The antenna assembly of claim 13, wherein the antenna assembly includes at least one post integrally defined by one of the composite antenna base and the printed circuit board, at least one opening integrally defined by the other one of said composite antenna base and said printed circuit board, and wherein the printed circuit board is mounted to the composite antenna base with the at least one post slidably received within the at least one opening.

15. The antenna assembly of claim 13, wherein the composite antenna base integrally defines a retaining wall, and wherein the printed circuit board is mounted to the composite antenna base such that that contact between the retaining wall and the printed circuit board inhibits relative movement thereof.

16. The antenna assembly of claim 13, further comprising at least one EMI shield component interposed generally between the printed circuit board and the composite antenna base for shielding the at least one antenna element.

17. The antenna assembly of claim 13, wherein the composite antenna base integrally defines one or more resiliently flexible retention members configured to be inserted through the mounting hole and disposed on the interior compartment side of the vehicle body wall to thereby help retain the relative position of the composite antenna base to the vehicle body wall before the antenna assembly is fixedly mounted to the vehicle body wall.

18. The antenna assembly of claim 13, further comprising at least one grounding element that forms at least a portion of a path to ground for the antenna assembly to the vehicle body wall.

19. The antenna assembly of claim 13, further comprising a radome attached to the composite antenna base, without mechanical fasteners, by at least one or more of a snap fit, heat staking, solvent welding, or sonic welding.

20. The antenna assembly of claim 13, further comprising a radome coupled to the composite antenna base, and at least one sealing member disposed for substantially sealing the interface defined generally between the radome and the composite antenna base, to thereby inhibit the ingress of contaminants through the interface into the interior enclosure collectively defined by the radome and composite antenna base, wherein the composite antenna base integrally defines at least one shoulder generally along the interface, and wherein the at least one sealing member is seated generally against the at least one shoulder.

21. The antenna assembly of claim 13, wherein the composite antenna base includes an opening, and wherein the antenna assembly further comprises an electrically-conductive insert at least partially positioned within the opening of the composite antenna base such that the electrically-conductive insert forms at least a portion of a path to ground for the antenna assembly to the vehicle body wall, the electrically-conductive insert configured for retaining a fastener element.

22. The antenna assembly of claim 21, wherein the electrically-conductive insert is internally threaded for threadedly engaging a threaded portion of a mechanical fastener.

23. An antenna assembly configured to be installed and fixedly mounted to a vehicle body wall after being inserted into a mounting hole in the vehicle body wall from an external side of the vehicle and nipped from the interior compartment side, the antenna assembly comprising a composite antenna base integrally defining one or more resiliently flexible retention members configured to be inserted through the mounting hole and disposed on the interior compartment side of the vehicle body wall to thereby help retain the relative position of the composite antenna base to the vehicle body wall before the antenna assembly is fixedly mounted to the vehicle body wall.

24. The antenna assembly of claim 23, wherein the composite antenna base is formed from a material having sufficient resiliency to permit the one or more resiliently flexible retention members to be deformed for fitting through the mounting hole and then to expand upon passing completely through the mounting hole.

25. The antenna assembly of claim 23, wherein the composite antenna base integrally includes a first portion configured to be disposed on the external side of the vehicle body panel, and a second protruding portion configured to be inserted into the mounting hole, the second protruding portion integrally defining the one or more resiliently flexible retention members and one or more tapered faces.

26. The antenna assembly of claim 23, further comprising at least one grounding element that forms at least a portion of a path to ground for the antenna assembly to the vehicle body wall.

27. The antenna assembly of claim 23, further comprising a radome attached to the composite antenna base, without mechanical fasteners, by at least one or more of a snap fit, heat staking, solvent welding, or sonic welding.

28. The antenna assembly of claim 23, further comprising a radome coupled to the composite antenna base, and at least one sealing member disposed for substantially sealing the interface defined generally between the radome and the composite antenna base, to thereby inhibit the ingress of contaminants through the interface into the interior enclosure collectively defined by the radome and composite antenna base, wherein the composite antenna base integrally defines at least one shoulder generally along the interface, and wherein the at least one sealing member is seated generally against the at least one shoulder.

29. The antenna assembly of claim 23, wherein the composite antenna base includes an opening, and wherein the antenna assembly further comprises an electrically-conductive insert at least partially positioned within the opening of the composite antenna base such that the electrically-conductive insert forms at least a portion of a path to ground for the antenna assembly to the vehicle body wall, the electrically-conductive insert configured for retaining a fastener element.

30. The antenna assembly of claim 29, wherein the electrically-conductive insert is internally threaded for threadedly engaging a threaded portion of a mechanical fastener.
